(19) United States
(12) Patent Application Publication
(10) Pub. No.: US 2017/0191269 A1
(43) Pub. Date: Jul. 6, 2017

(54) HIGH-STRENGTH FASTENING DEVICE

(71) Applicant: FIREP REBAR TECHNOLOGY GMBH, Düsseldorf (DE)

(72) Inventor: Kenichi TSUKAMOTO, Meerbusch (DE)

(73) Assignee: FIREP REBAR TECHNOLOGY GMBH, Düsseldorf (DE)

(21) Appl. No.: 15/317,470

(22) PCT Filed: Jun. 9, 2015
(86) PCT No.: PCT/EP2015/062865

§ 371 Date: Mar. 17, 2017

(30) Foreign Application Priority Data
Jun. 10, 2014 (DE) 10 2014 008 166.4

(51) Int. Cl. E04C 5/12; E02D 5/74; E21D 21/00; F16B 13/08

(52) U.S. Cl. CPC E04C 5/122; F16B 13/08; E02D 5/74; E21D 21/008

(57) ABSTRACT

The invention relates to a fastening device for fastening at least one mounting element to a threaded bolt, including a nut having a threaded bore and a clamping element that interacts with the nut and has an opening. The nut has a conical supporting region on the outside. In the mounted state, the nut engages at least partly in the opening of the clamping element and rests on a complimentary inner cone which the clamping element has. The nut has at least one slot which interrupts the nut wall over a sub region of the axial extent of the latter. The at least one slot opens at the axial end of the nut which is located closer to the larger diameter than to the smaller diameter of the conical supporting region is designated as the top end. The clamping element can be screwed into a mounting element.

The present invention relates to a fastening device according to the generic part of claim 1. It serves to fasten a mounting element provided with an opening on a threaded bolt extending through the opening of the mounting element. To this end the fastening device comprises on the one hand a nut with a threaded bore for being screwed onto an outer threading of a threaded bolt, and on the other hand comprises a clamping element cooperating with the nut and with an opening or bore. The clamping element has the purpose of transferring the axial forces that can be exerted on the nut by a threaded bolt that can be screwed into the nut in at least an axial direction onto a mounting element surrounding the threaded bolt. The forces can then be transferred from the mounting element onto other elements.

The nut of the fastening device has a conical support area on its outside with which it engages in the mounted state at least partially into the opening or bore of the clamping element and rests there on a complementary inner cone which the clamping element comprises on at least a partial area of its opening or bore. In order to increase the carrying capacity and to achieve greater strength values, the nut has at least one slot which interrupts the nut wall over a partial area of its axial extension.

Such a fastening device is known from DE 10 2010 024 352 A1 in the special construction as an anchor nut on a traction anchor. The clamping element is formed in it by a seat ring which transmits the tractive forces exerted by the traction anchor via a mounting element formed here by an anchor plate to the foundation surrounding the anchor bore.

Furthermore, it is known for example from DE 20 2008 003 381 U1 in anchor heads for traction anchors to provide a traditional anchor nut without slot which engages with a conical support area in the mounted state into the opening of an anchor plate and rests there on a complementary inner cone of the anchor plate.

Furthermore, an anchor nut is known from AT 135 919 B whose wall is interrupted at a position of its circumference over the entire level of the anchor nut by a slot.

Furthermore, a fastening device for fastening a mounting element on a threaded bolt is known from DE 10 2013 002 734 A1 published after the priority date of the present application, which device is constructed as an anchor head for anchoring a traction anchor on the air side of an anchor bore. This anchor head comprises an anchor nut with a threaded bore for being screwed onto an anchor threading of a traction anchor, and comprises an anchor plate cooperating with the anchor nut and with an anchor plate opening for transferring the traction forces which can be exerted by a screwed-in traction anchor onto the anchor nut onto a foundation surrounding the anchor bore. The anchor nut has a conical support area with which it engages in the mounted state at least partially into the anchor plate opening of the anchor plate and rests there on a complementary inner cone which the anchor plate comprises in the area of the anchor plate opening. The anchor nut comprises at least one slot running axially parallel which interrupts the nut wall over a partial area of its axial extension, wherein the at least one slot empties at the axial end of the anchor nut which is located closer to the greater diameter than to the smaller diameter of the conical support area and extends starting from there over a length which is between 25% and 90% of the total axial length of the anchor nut. However, the outer threading does not have any outer threading here so that it cannot be screwed into a mounting element.

The present invention has the problem of creating a fastening device of the initially cited type which can be economically produced, is easy to handle and achieves an especially high carrying capacity and improved strength values with a simple construction.

The invention solves this problem with a fastening device according to Claim 1. Advantageous embodiments and further developments of the invention result from the dependent claims.

It is essential for the solution according to the invention that the at least one slot empties at the axial end of the nut which is closer to the area of the larger diameter than to the area of the smaller diameter of the conical support area, wherein the at least one slot extends starting from there over a length which is between 20% and 95% of the total axial length of the nut, and that the clamping element comprises an outer threading at least in a partial area with which it can be screwed into a mounting element.

The axial end, on which the slot empties, is designated in the present application also as an upper or topside end of the nut. The axially opposite, other end is accordingly also called the bottom or lower end of the nut.

The length of the slot is preferably between 25% and 88% and especially preferably between 45% and 85% of the total axial length of the nut.

In contrast to the previously known fastening devices, the slot interrupting the nut wall is not located on the bottom end of the nut but rather on its upper end, wherein it does not extend over the total length of the nut.

As a result, in contrast to the previously known designs, improved clamping distributions inside the fastening device are achieved. As a result of the better transfer of force from the nut onto a screwed-in threaded bolt, increased carrier loads and higher strength values can be achieved.

As the tractive forces of a threaded bolt screwed into the nut increase, the nut is drawn increasingly deeper into the inner cone of the clamping element so that a first, radially acting pressure brings about an at first elastic deformation in the bottom, non-slotted area of the nut cone which results in a further axial elevation of the carrier load of the nut.

Upon a further axial increasing of the load or of another load upon traction in the threaded bolt, the radially acting pressure is increased further and therefore leads to a further deformation and also, by superposing, to a plastic deformation of the nut cone which now extends over the axial length of the nut in the direction of the slotted area. Here, the deformation resistance of the nut to the radial pressure does not rise further in spite of the increasing diameter in the outer cone but rather, based on the slots arranged according to the invention in this upper area, an evening out of the specific surface pressure by the inner cone of the clamping element takes place on the whole on the entire surface of the nut cone, as a result of which the load capacity of the nut is considerably increased. All threading ribs of the nut are then used to an almost equal extent for the transfer of force, which is not the case in the previously known fastening devices with nuts with slots arranged on the bottom.

As a result of the simple manner of construction, the fastening device of the invention can be economically produced and readily managed when used.

The nut wall in the lower area of the conical support area, which is located axially behind the at least one slot when viewed from the upper end is advantageously constructed continuously over the entire circumference without interruption.

It is especially advantageous if the slot or the slots run(s) parallel to the screw axis of the nut.

A preferred embodiment provides that the circumferential areas of the nut wall which remain in the prolongation of the slot or slots are constructed as theoretical breaking position(s) which break(s) when a predetermined load is exceeded.

It is especially advantageous if the nut comprises several slots which are uniformly distributed along the circumference. Preferably two to six slots, in particular four slots are provided which oppose each other in pairs.

Furthermore, it is especially advantageous if the slotted area on the upper end of the nut is inwardly compressed in such a manner during the clamping of a threaded bolt screwed into the nut by the penetration of the conical support area of the nut into the inner cone of the clamping element that not only the axial threading play but also the radial threading play between the nut and the screwed-in threaded bolt are reduced or even completely eliminated. As a result, on the one hand maximum carrying loads and strength values of the fastening device can be achieved and on the other hand slip-free fastenings, e.g., even of reinforcement rods when concrete is used can be achieved.

According to an advantageous embodiment of the invention a head area follows the upper end of the conical support area of the nut, the circumferential profile of which head area is constructed in such a manner as to apply a torque in a known manner with positive elements, preferably with an outside hexagon.

The head area can outwardly project and form a bottom, axial stop surface with which the nut can be brought to rest on other mounting elements, in particular on the perforated plate. Even the bottom stop surface of the head area can strike against a complementary stop surface of the clamping element in order to prevent a further drawing in of the conical area of the nut into the inner cone of the clamping element by this positive locking. In this manner a defined stroke of the axial movement of the nut in the inner cone of the clamping element and therewith also the system flexibility can be limited in a defined manner.

Furthermore, it can be advantageous if at least one of the contact surfaces of the conical pairing between the nut and the clamping element is provided with a friction-reducing coating or with a friction-reducing insert, in particular with a nylon insert. This makes a greater clamping possible at the same torque.

Another preferred embodiment of the invention provides that the clamping element comprises a radially outwardly projecting collar which forms an axial stop surface advantageously running vertically to the longitudinal axis or to the axis of rotation of the clamping element. This stop surface can make contact, for example, with an anchor plate for the axial transfer of force to other mounting elements which have a bore which receives the clamping element. In this manner an especially multiply usable fastening device is obtained in which the forces transferred from the threaded bolt via the nut onto the clamping element can be forwarded either via a threaded connection or positively via the stop surface formed on the collar to other mounting elements.

It is especially advantageous if the outer threading of the clamping elements is introduced into the circumferential surface of the collar. Alternatively, the outer threading can also be introduced into a circumferential surface of the clamping element which follows the stop surface underneath the collar.

An alternative, advantageous embodiment of the invention suggests that it comprises a second nut designated as the outer nut which can be screwed onto the outer threading of the clamping element and which forms an axial stop surface on at least one of its front surfaces. Another mounting element with a bore, for example an anchor plate, receiving the clamping element can also come to rest on the stop surface of this outer nut for the axial transfer of force. A post-clamping of the traction anchor can be carried out here in an especially simple manner when used on a traction anchor in particular in the case of setting phenomena occurring during a subsequent tightening of the outer nut.

In an especially advantageous instance of application the fastening device forms an anchor head or at least a part of an anchor head for anchoring a traction anchor. Here the traction anchor forms the threaded bolt and an anchor plate of the anchor head forms a mounting element of the initially cited type provided with an opening.

Another important advantage of the outer threading of the clamping element is the fact that even the achieved strength of the connection can be tested here. Thus, there is, for example, the possibility of positioning a withdrawal device on the outer threading of the clamping element and of checking with it the tensile strength of the connection to the threaded bolts achieved by the fastening device.

Another especially preferred embodiment of the invention provides that the fastening device comprises two in particular identically constructed nuts and two also preferably identically constructed clamping elements which can cooperate in pairs as a combination of a nut and of a clamping element in the previously described manner, wherein a preferably tubular mounting element serving as a coupling element is additionally provided which has two inner threaded areas into which one of the two clamping elements can be screwed with its outer threading.

If a threaded bolt is screwed into each nut and the two clamping elements are screwed into the coupling element, the two threaded bolts are especially firmly connected to one another by the two nuts and the two clamping elements as well as by the coupling element arranged between them. This arrangement with two fastening devices of the previously described type is therefore used in this manner as a system for connecting two threaded bolts to one another which are arranged at least substantially coaxially and successively.

The nuts and the associated clamping elements as well as the optionally additionally provided tubular coupling element or optionally provided other nuts of the fastening device preferably consist of a metallic allow. A threaded bolt or anchor on which the fastening device is used can consist either of metal or preferably of fiber-reinforced plastic, in particular of glass fiber-reinforced plastic (GFK).

Other advantages and features of the invention result from the following description and the exemplary embodiments shown in the drawings. In the drawings:

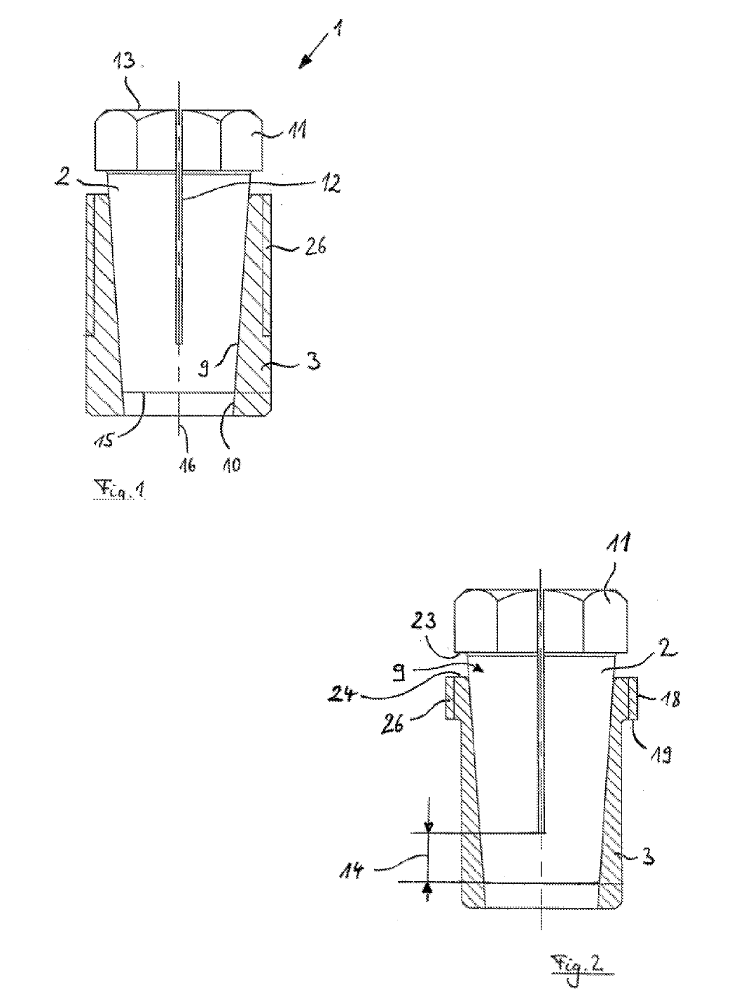

FIG. 1 shows a cross section through a first embodiment of a fastening device according to the invention;

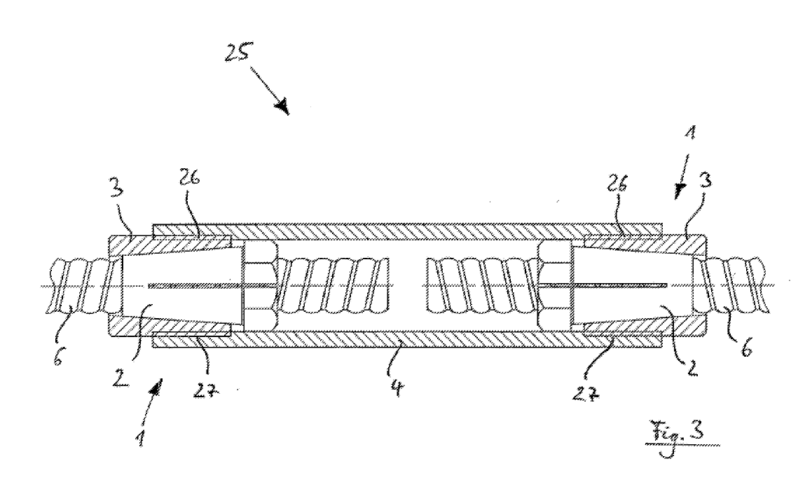

FIG. 2 shows a cross section through a second embodiment of a fastening device according to the invention;

FIG. 3 shows a cross section through an arrangement of the invention with two fastening devices according to FIG. 1;

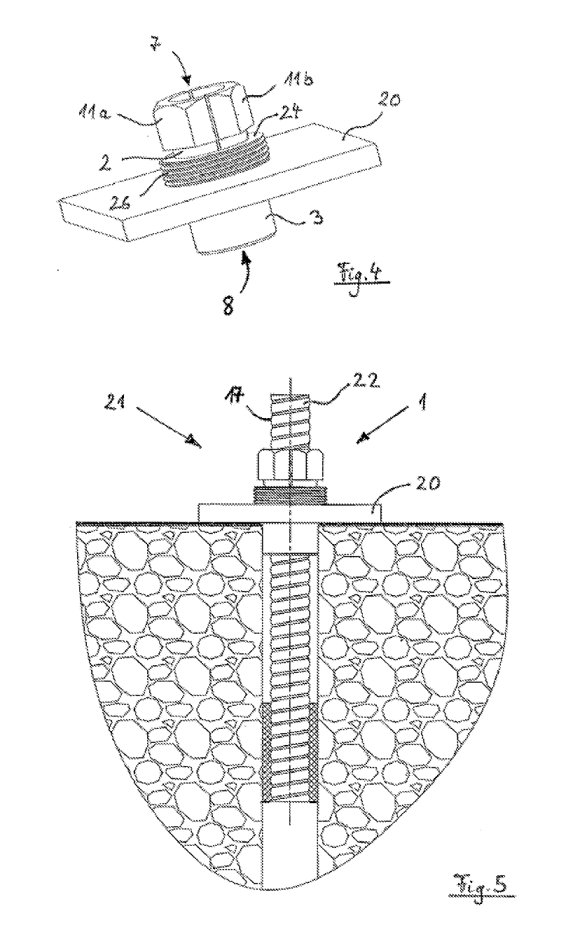

FIG. 4 shows a view of an embodiment of a fastening device corresponding to FIG. 2;

FIG. 5 shows the fastening device from FIG. 4 on a traction anchor in a set state;

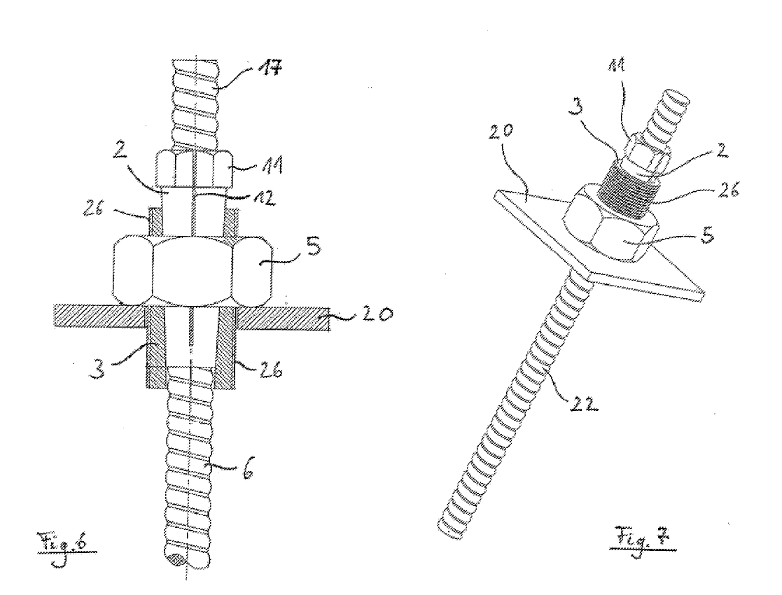

FIG. 6 shows a cross section through a third embodiment of a fastening device according to the invention; and

FIG. 7 shows a view of a fastening device according to FIG. 6.

The exemplary embodiments of fastening devices 1 according to the invention and shown in the figures each comprise a nut 2 and an associated clamping element 3 as essential components. Each fastening device 1 serves to fasten one or more other mounting elements, for example a tubular casing 4 or a second nut 5, on a threaded bolt 6. To this end the nut 2 has a threaded bore 7 and the clamping element 3 has a central through opening 8 through which a threaded bolt 6 can be run.

The body of the nut 2 has a conical support area 9 which engages in the mounted state into the opening 8 of the clamping element 3. There, the conical support area 9 of the nut 2 lies on a complementary inner cone 10 which the clamping element 3 has as a circumferential wall of the opening 8. The conical support area 9 and also the inner cone 10 are constructed to be self-locking here with a conical angle of 7.5°.

A head area 11 of the nut 2 for applying a torque for a desired clamping with an outer hexagon follows the upper end of the conical support area 9, which has the greater diameter in comparison to the lower end.

In order to increase the carrying capacity and to achieve higher strength values, the nut 2 has two diametrically opposed slots 12 running in an axially parallel manner which interrupt the nut wall over the length of its axial extension. According to the invention these slots 12 are arranged in such a manner that they begin on the upper end 13 of the nut 2 and end at a distinct distance 14 from the lower end 15 of the nut 2. In the exemplary embodiments of FIGS. 1, 2 and 3 the slots 12 extend starting from the upper end 13 over a length that is between 80% and 85% of the entire axial length of the nut 2. In the exemplary embodiment in FIG. 6 the slots 12 extend over a length of approximately 90% of the total axial length of the nut 2.

The two slots 12 separate the head area 11 and the predominant part of the conical support area 9 into two segments Ila and 1 lb. Only the lower end of the conical support area 9 with a smaller diameter is constructed at a height 14 of circa 15% to 20% of the axial length of nut 2 continuously over the entire circumference.

In the direction of the longitudinal axis 16 the nut 2 is provided with a continuous threaded bore 7 whose inner threading is adapted to the threading 17 of the threaded bolt 6. Therefore, the nut 2 can readily be screwed at first on to the threaded bolt 6 with a slight play, in contrast to which the inner threading of the nut 2 is fixed without play and slippage on the threading 17 of the threaded bolt 6 with a radial pressing or clamping of the conical support area 9 in the inner cone 10.

In FIGS. 2, 4 and 5 the clamping element 3 comprises on its upper end a radially outwardly projecting collar 18 which forms an axial stop surface 19 on its bottom front side. The stop surface 19 can be supported, for example, on an anchor plate 20 if the fastening device for an anchor head 21 of a traction anchor 22 is used (FIG. 5).

Even the head area 11 of the nut 2 has a stop surface 23 running vertically to the longitudinal axis 16 on its lower front surface. This stop surface 23 can strike against a complementary stop surface 24 formed on the upper side of the clamping element 3. This positive locking then prevents a further drawing in of the conical support range 9 of the nut 2 into the inner cone 10 of the clamping element 3.

The arrangement 25 according to the invention and shown in FIG. 3 comprises two identical fastening devices 1 from FIG. 1. They are screwed with the outer threading 26 of the clamping element 3 into one of two inner threadings 27 which comprises a tubular mounting element 4 on both its ends. In this manner two coaxial threaded bolts 6 which are screwed into a nut 2 of a fastening device Tare connected to one another in a very firm manner by the tubular mounting element 4 forming a coupling element. In the exemplary embodiment shown the two nuts 2 and the two clamping elements 3 as well as the tubular mounting element 4 consist of steel, in contrast to which the two threaded bolts 6 preferably consist of glass fiber-reinforced plastic (GFK).

In the exemplary embodiment shown in the FIGS. 6 and 7 a second nut 5 which is designated as the outer nut is screwed onto the outer threading 26 of the clamping element 3. It rests with its bottom front surface, which forms an axial stop surface, on a plate-shaped mounting element, for example on an anchor plate 20. After the very firm connection of the fastening device 1 has been established with the threaded bolt 6 or traction anchor 22, additional clamping can be applied in this embodiment by subsequently tightening the outer nut 5, which allows, for example, a simple readjustment in the case of setting phenomena, for example in the case of a traction anchor 22.

1. A fastening device (1) for fastening at least one mounting element on a threaded bolt (6), comprising
a nut (2) with a threaded bore (7), and
a clamping element (3) cooperating with the nut (2) and with an opening (8), wherein the nut (2) comprises an outside, conical support area (9) with which it engages in the mounted state at least partially into the opening (8) of the clamping element (3) and rests there on a complementary inner cone (10) comprised by the clamping element (3), and wherein the nut (2) has at least one slot (12) which interrupts the nut wall over a partial area of its axial extension,
wherein the at least one slot (12) empties at the axial end of the nut (2) which is closer to the larger diameter than to the smaller diameter of the conical support area (9), and which is designated as the upper end,
wherein the at least one slot (12) extends starting from there over a length which is between 20% and 95% of the total axial length of the nut (2), and wherein the clamping element (3) comprises an outer threading (26) at least in a partial area with which it can be screwed into a mounting element.

2. The fastening device (1) according to claim 1, wherein the nut wall, which is located axially behind the at least one slot (12) when viewed from the upper end is constructed continuously over the entire circumference without interruption.

3. The fastening device (1) according to claim 1, wherein the at least one slot (12) runs parallel to the axis or rotation (16) of the nut (2).

4. The fastening device (1) according to claim 1, wherein the circumferential areas of the nut wall which remain in the prolongation of the at least one slot (12) are constructed as a theoretical breaking position which breaks when a predetermined load is exceeded.

5. The fastening device (1) according to claim 1, wherein the nut (2) comprises several slots (12), which are uniformly distributed along the circumference.

6. The fastening device (1) according to claim 1, wherein the slotted area on the upper end of the nut (2) can be inwardly compressed during the penetration of the conical support area (9) into the inner cone (10) of the clamping element (3) so that the radial and the axial threading play between the nut (2) and a threaded bolt (6) which can be screwed into the nut (2) are reduced.

7. The fastening device (1) according to claim 1, wherein a head area (11) with a multi-edge circumferential profile follows the upper end of the conical support area (9) of the nut (9).

8. The fastening device (1) according to claim 1, wherein at least one of the contact surfaces of the conical pairing (9, 10) between the nut (2) and the clamping element (3) is provided with a friction-reducing coating.

9. The fastening device (1) according to claim 1, wherein the clamping element (3) comprises a radially outwardly projecting collar (18) which forms an axial stop surface (19).

10. The fastening device (1) according to claim 9, wherein the outer threading (26) of the clamping element (3) is introduced into the circumferential surface of the collar (18).

11. The fastening device (1) according to claim 1, wherein it comprises a second nut (5) which can be screwed onto the outer threading (26) of the clamping element (3) and which forms an axial stop surface on at least one of its front surfaces.

12. The fastening device (1) according to claim 1, wherein it forms an anchor head (21) or at least a part of an anchor head (21) for anchoring a traction anchor (22).

13. The fastening device (1) according to claim 1, wherein it comprises two nuts (2) and two clamping elements (3) which cooperate in pairs, and that it comprises tubular mounting element (4) which has two inner threaded areas (27) into which one of the two clamping elements (3) can be screwed.

14. The fastening device (1) according to claim 13, wherein a threaded bolt (6) is screwed into each nut (2) and that the two clamping elements (3) are screwed into the mounting element (4) so that the two threaded bolts (6) are connected to one another by the two nuts (2), the two clamping elements (3) and by the coupling element (4).

15. The The fastening device (1) according to claim 5 wherein the nut (2) comprises 2 to 6 slots.
